(19) United States
(12) Patent Application Publication
(10) Pub. No.: US 2025/0356049 A1
(43) Pub. Date: Nov. 20, 2025

(54) Information Processing Method and Recording Medium

(71) Applicant: SCREEN Holdings Co., Ltd., Kyoto (JP)

(72) Inventors: Hideaki HOSHINO, Kyoto (JP); Masaki INOMATA, Kyoto (JP); Keiryu SHUU, Kyoto (JP); Yasunori NAKAMURA, Kyoto (JP)

(21) Appl. No.: 19/199,454

(22) Filed: May 6, 2025

(30) Foreign Application Priority Data
May 16, 2024 (JP) 2024-080255

(51) Int. Cl. G06F 21/62; G06F 40/279

(52) U.S. Cl. CPC G06F 21/6245; G06F 40/279

(57) ABSTRACT

The invention provides a technique capable of effectively reducing leakage of confidential information included in text and appropriately disclosing information to a reader. A confidential-information masking part acquires to-be-processed text that includes an object concept to be concealed. The confidential-information masking part acquires a reader attribute that indicates the attribute of a reader of the to-be-processed text. The confidential-information masking part abstracts, according to the reader attribute, the object concept included in the to-be-processed text by using a conceptual information tree that defines a hierarchical relationship of concepts.

### RELATED APPLICATIONS

This application claims the benefit of Japanese Application No. 2024-080255, filed on May 16, 2024, the disclosure of which is incorporated by reference herein.

### BACKGROUND OF THE INVENTION

### Field of the Invention

The subject matter disclosed in the specification of the present invention relates to an information processing method and a recording medium.

### Description of the Background Art

Conventionally, there is known a system that outputs an answer to a question input from a user by using a machine learning model that uses sets of document data as training data (e.g., Japanese Unexamined Patent Application Publication No. 2024-049674).

### SUMMARY OF THE INVENTION

### Technical Problem

In the case where the training data includes confidential information, text including the confidential information may be output from the machine learning model. In this case, there is a risk of the confidential information being leaked if the output text is viewed by a reader who should not have access to the confidential information. On the other hand, if the confidential information is masked completely, a reader may not be able to effectively comprehend information included in the output text.

An object of the present disclosure is to provide a technique capable of appropriately disclosing information to a reader while effectively reducing leakage of confidential information included in text.

### Solution to Problem

In order to solve the problems described above, a first aspect is an information processing method that is executed by a computer. The information processing method includes a) acquiring to-be-processed text that includes an object concept to be concealed, b) acquiring a reader attribute that indicates an attribute of a reader of the to-be-processed text, and c) abstracting, according to the reader attribute, the object concept included in the to-be-processed text by using ontology information that defines a hierarchical relationship of a plurality of concepts.

A second aspect is the information processing method according to the first aspect, in which the ontology information defines a conceptual hierarchy level for each concept, the reader attribute is information indicating a specific conceptual hierarchy level, and the operation c) includes abstracting the object concept included in the to-be-processed text when the specific conceptual hierarchy level indicated by the reader attribute is higher than a conceptual hierarchy level of the object concept.

A third aspect is the information processing method according to the second aspect, in which the operation c) includes replacing the object concept included in the to-be-processed text with a concept that is at the specific conceptual hierarchy level indicated by the reader attribute when the conceptual hierarchy level of the object concept is lower than the specific conceptual hierarchy level.

A fourth aspect is the information processing method according to any one of the first to third aspects, in which the ontology information defines a disclosure range for each concept, the reader attribute is information indicating whether the reader attribute is included in the disclosure range, and the operation c) includes abstracting the object concept included in the to-be-processed text when the reader attribute is not included in the disclosure range of the object concept.

A fifth aspect is the information processing method according to the fourth aspect, in which the operation c) includes, when the reader attribute is not included in the disclosure range of the object concept included in the to-be-processed text, replacing the object concept with a concept that is a higher-level concept than the object concept and that includes the reader attribute in the disclosure range.

A sixth aspect is the information processing method according to the fifth aspect, in which the disclosure range becomes larger as the hierarchical relationship of concepts is at a higher level in the ontology information.

A seventh aspect is a recording medium having recorded thereon a computer program that is executable by a computer, the computer program causing the computer to execute the information processing method according to any one of the first to sixth aspects.

According to the first to seventh aspects, the to-be-processed text is abstracted according to the attribute of the reader. Thus, information to be disclosed to the reader is restricted according to the reader. Accordingly, it is possible to appropriately disclose information to the reader while effectively reducing leakage of the confidential information.

With the information processing method according to the second aspect, the to-be-processed text can be abstracted based on the hierarchical attribute.

With the information processing method according to the fourth aspect, the to-be-processed text can be abstracted based on the disclosure range.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a configuration of an information processing apparatus according to a first embodiment.

FIG. 2 is a block diagram schematically showing information processing that is executed by the information processing apparatus according to the first embodiment.

FIG. 3 is a diagram showing a conceptual information tree that is ontology information according to the first embodiment.

FIG. 4 is a diagram conceptually showing how an instance with a reader attribute is generated.

FIG. 5 is a diagram for describing a correspondence between the reader attribute and a hierarchical attribute in the conceptual information tree.

FIG. 6 is a diagram showing a procedure for processing to-be-processed text, together with a specific example.

FIG. 7 is a diagram showing a conceptual information tree Ta that is ontology information according to a second embodiment.

FIG. 8 is a diagram conceptually showing how an instance with a reader attribute R is generated.

FIG. 9 is a diagram showing concepts that the reader with a reader attribute R-5 is permitted to view in the conceptual information tree Ta shown in FIG. 7.

FIG. 10 is a diagram showing a viewable range table.

FIG. 11 is a diagram showing a conceptual information tree Tb that is ontology information according to a third embodiment.

FIG. 12 is a diagram showing concepts that the reader with a reader attribute D-3 is permitted to view.

FIG. 13 is a diagram showing concepts that the reader with a reader attribute R-2 corresponding to a disclosure range is permitted to view.

### DESCRIPTION OF THE PREFERRED EMBODIMENTS

Embodiments of the present invention are described hereinafter with reference to the accompanying drawings. Constituent elements described in these embodiments are merely illustrative examples, and the scope of the present invention is not intended to be limited by them. To facilitate understanding of the drawings, the dimensions or number of each constituent element may be illustrated in exaggerated or simplified form as necessary.

### 1. First Embodiment

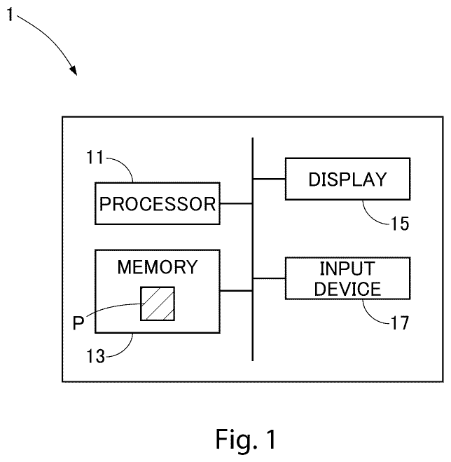

FIG. 1 is a diagram showing a configuration of an information processing apparatus 1 according to a first embodiment. The information processing apparatus 1 is a computer that includes a processor 11 and memory 13. The processor 11 may include, for example, a central processing unit (CPU). The memory 13 may include, for example, read-only memory (ROM) or random-access memory (RAM). Note that the memory 13 may include auxiliary memory such as a hard disk drive (HDD) or a solid-state drive (SSD). The memory 13 is connected to the processor 11 via a system bus.

The memory 13 stores a computer program P. The computer program P can be executed by the processor 11 of the information processing apparatus 1. When the processor 11 executes the computer program P, information processing described later is executed in the information processing apparatus 1. The computer program P may be recorded on a non-transitory recording medium. The recording medium may, for example, be an optical medium or semiconductor memory such as USB memory. The computer program P recorded on the recording medium is readable by a reading device not shown. Note that the computer program P may be stored in the memory 13 via a network line not shown.

The information processing apparatus 1 includes a display 15 and an input device 17. The display 15 and the input device 17 are connected to the processor via the system bus. The display 15 is a device that visually displays outputs of the information processing apparatus 1, and is specifically a liquid crystal display. The input device 17 is a device that enables a user to input data or instructions to the information processing apparatus 1, and is specifically a keyboard, a mouse, or the like. Note that the display 15 may be allowed to function as the input device 17 by including, for example, a touch panel in the display 15.

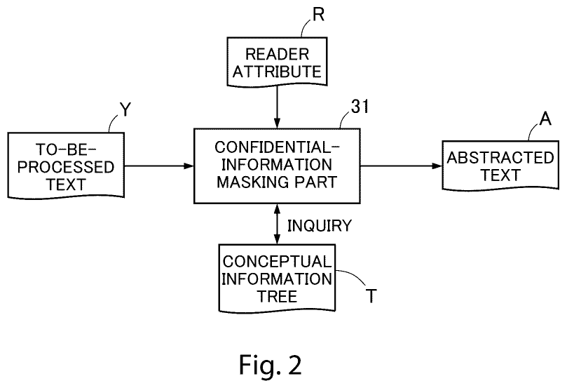

FIG. 2 is a block diagram schematically showing information processing that is executed by the information processing apparatus 1 according to the first embodiment. A confidential-information masking part 31 shown in FIG. 2 is a function realized by the processor 11 executing the computer program P. The confidential-information masking part 31 abstracts confidential information included in to-be-processed text Y so as to output abstracted text A that includes the masked confidential information. The to-be-processed text Y may, for example, be text such as e-mail text that is input from a user via an input device, text that is stored in the memory 13 or the like of the information processing apparatus 1, or text that is acquired from a database or the like.

Note that the to-be-processed text Y may also be text that is generated by a text generation model. The text generation model is specifically a large language model (LLM). LLM is a deep neural network based on a self-attention mechanism called Transformer. Transformer is capable of capturing the relationship of an input sequence as a whole by the self-attention mechanism.

The confidential-information masking part 31 uses a conceptual information tree T to abstract confidential information (object concept) that is included in the to-be-processed text Y and is to be concealed, according to a reader attribute R acquired in advance. The conceptual information tree T is ontology information that includes a plurality of concepts and defines a hierarchical relationship of these concepts.

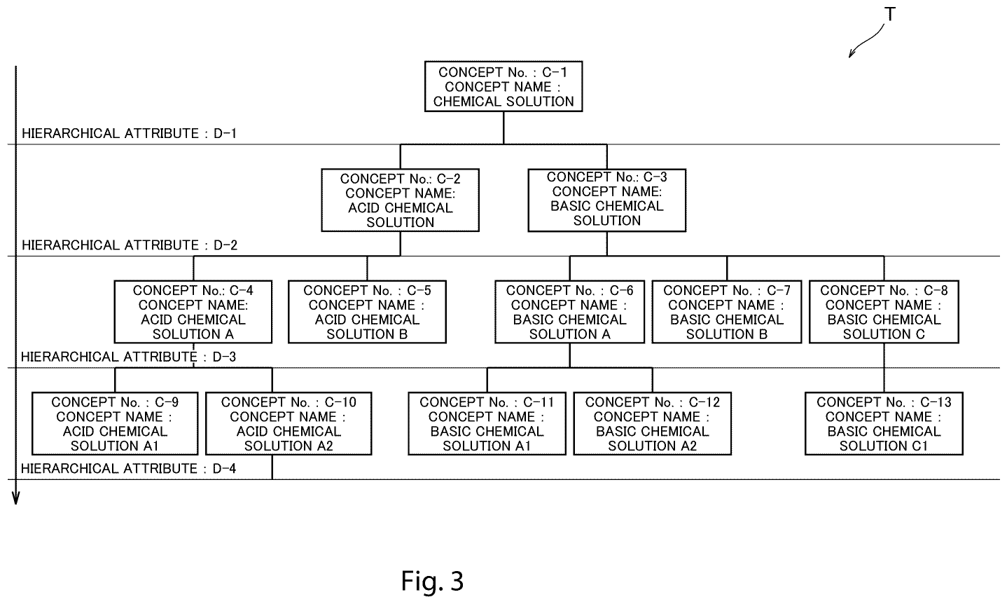

FIG. 3 is a diagram showing the conceptual information tree T that is ontology information according to the first embodiment. In the conceptual information tree T, one concept number (identifier) and one concept name (a word for a specific expression of a concept) associated with the concept number is assigned to each concept. For example, the concept with the concept number C-1 has a concept name of “chemical solution.” In the conceptual information tree T, the hierarchical relationship of the concepts is described in a tree structure. In FIG. 3, for example, “chemical solution” is the highest-level concept (route concept), and “acid chemical solution” (C-2) and “basic chemical solution” (C-3) are defined as lower-level concepts immediately under the route concept. Moreover, “acid chemical solution A” (C-4) and “acid chemical solution B” (C-5) are defined as lower-level concepts immediately under “acid chemical solution.” Note that the concept name such as “acid chemical solution A” is merely a notational example used for the convenience of description, and in actuality a specific chemical solution name may be assigned to each concept.

The conceptual information tree T according to the present embodiment also defines a hierarchical attribute D that indicates a conceptual hierarchy level for each concept. The hierarchical attribute Dis information indicating the depth from the concept used as a reference (here, the highest-level route concept). In the example shown in FIG. 3, “D-1” is defined as the hierarchical attribute of “chemical solution” serving as the route concept, and each time the depths of conceptual hierarchy levels increase by one, hierarchy attribute numbers increase by one, such as “D-2,” “D-3,” and so on.

Although the conceptual information tree T shown in FIG. 3 includes only one route concept, the conceptual information tree T may include a plurality of types of route concepts. Then, the conceptual information tree T may have a tree structure for each route concept.

The conceptual information tree T is prepared in advance by, for example, a user and stored together with the computer program P in the memory 13. Alternatively, the conceptual information tree T may also be stored in, for example, a server other than the information processing apparatus 1. In this case, a system may be constructed in which the information processing apparatus 1 accesses the conceptual information tree T via a network line such as the Internet.

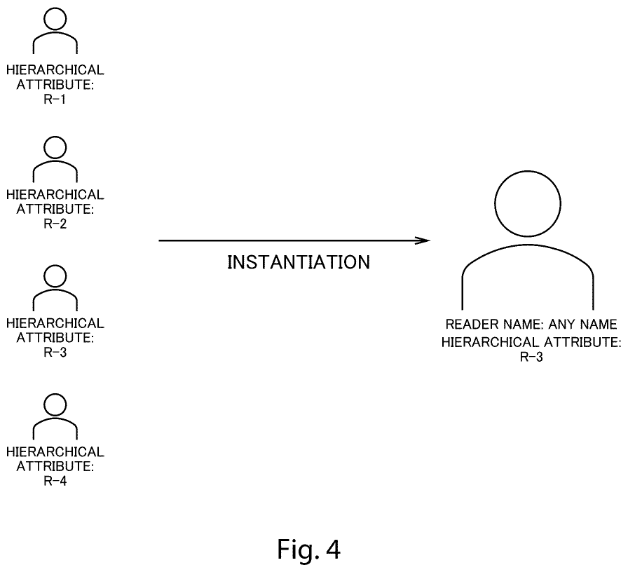

FIG. 4 is a diagram conceptually showing how an instance with the reader attribute R is generated. In the present embodiment, the reader attribute R corresponding to the reader is defined in advance in order to reduce leakage of the confidential information included in the to-be-processed text Y. The reader attribute R is information indicating the level of abstraction (authority) of the confidential information that the reader is permitted to view. In the example shown in FIG. 4, the reader attributes R-1, R-2, and so on are defined for each hierarchy level of the readers. When a user has designated the hierarchy level of the reader, the information processing apparatus 1 generates an instance with the reader attribute R corresponding to the hierarchy level of the reader. Note that setting the hierarchy level of the reader based on input of designation from the user is not essential. For example, in the case where the confidential-information masking part 31 processes e-mail text, the hierarchy level of the reader may be set based on the e-mail destination.

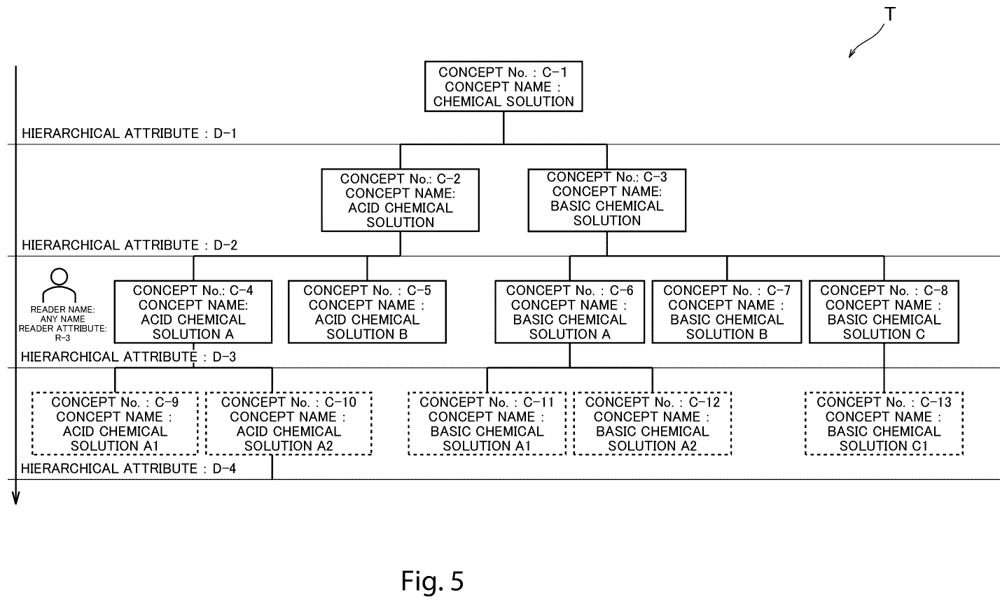

FIG. 5 is a diagram for describing a correspondence between the reader attribute R and the hierarchical attribute D in the conceptual information tree T. The reader attribute R according to the present embodiment is information indicating a specific conceptual hierarchy level. That is, the reader attribute R corresponds to a specific hierarchical attribute D. More specifically, the reader attributes R-1, R-2, R-3, and so on correspond respectively to hierarchical attributes D-1, D-2, D-3, and so on.

For example, a case is assumed in which the reader attribute R-3 corresponds to the hierarchical attribute D-3. In this case, as shown in FIG. 5, the reader with the reader attribute R-3 is permitted to view concepts with the hierarchical attribute D-3 corresponding to the reader attribute R-3 and concepts with hierarchical attributes D-1 and D-2 that are at higher levels than the hierarchical attribute D-3 (the concepts indicated by solid boxes in FIG. 4). The reader is prohibited from viewing concepts with hierarchical attributes such as D-4 that are at lower levels than the hierarchical attribute D-3 corresponding to the reader attribute R-3 (the concepts indicated by broken boxes in FIG. 4).

In the case where the to-be-processed text Y includes a word under a concept with the hierarchical attribute D that is prohibited from being viewed by the reader (i.e., the hierarchical attribute at a lower level than the hierarchical attribute indicated by the reader attribute R), the confidential-information masking part 31 abstracts the word to a concept with a hierarchical attribute D that the reader is permitted to view. For example, in the case where the reader attribute is D-3 and the to-be-processed text Y includes a word under the concept with the hierarchical attribute D-4, the confidential-information masking part 31 replaces the word with a word under the concept with the hierarchical attribute D-3 corresponding to the reader attribute R-3. Alternatively, the confidential-information masking part 31 may replace the word with a word under the concept with any hierarchical attribute D (e.g., D-2 or D-1) at a higher level than the hierarchical attribute D-3 corresponding to the reader attribute R-3.

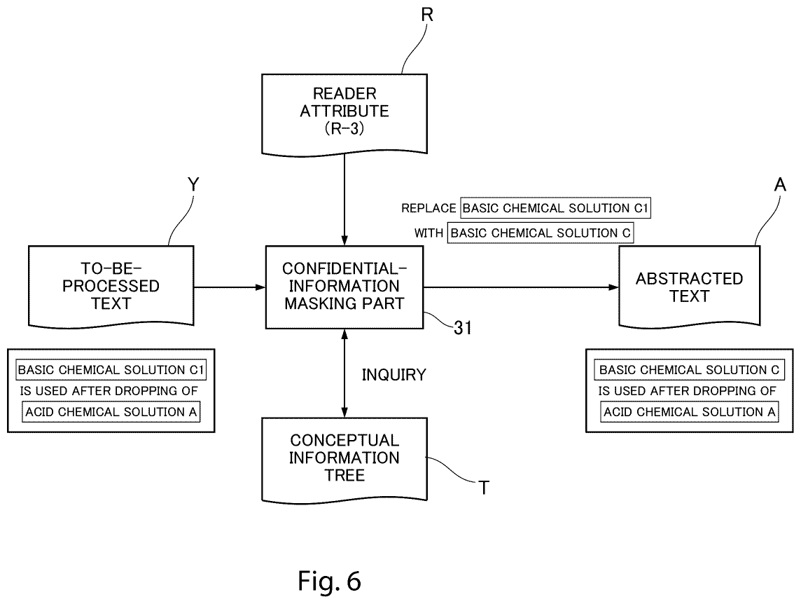

FIG. 6 is a diagram showing a procedure for processing the to-be-processed text Y, together with a specific example. The confidential-information masking part 31 first analyzes the to-be-processed text Y to divide the text into words and acquires the reader attribute R of an instance. In the example shown in FIG. 6, the to-be-processed text Y is a sentence saying “basic chemical solution C1 is used after dropping of acid chemical solution A,” and the reader attribute R is “R-3.”

The confidential-information masking part 31 queries the conceptual information tree T to find a word included in the analyzed to-be-processed text Y, and identifies a word that is included in the to-be-processed text Y but prohibited from being viewed by the reader. Then, the confidential-information masking part 31 generates abstracted text A by replacing the identified word with a word that the reader is permitted to view. In the present example, the to-be-processed text Y includes “acid chemical solution A” with the hierarchical attribute D-3 and “basic chemical solution C1” with the hierarchical attribute D-4, so that “basic chemical solution C1” is identified as a word that the reader is prohibited from viewing. Then, the confidential-information masking part 31 generates the abstracted text A by replacing “basic chemical solution C1” with “basic chemical solution C” that the reader is permitted to view.

The abstracted text A is displayed on the display 15 so as to enable the reader to view the abstracted text A. The confidential information (i.e., words registered in the conceptual information tree T) included in the to-be-processed text Y is abstracted according to the reader attribute R of the reader. Thus, information to be disclosed to the reader is restricted according to the reader, and the reader is able to comprehend the meaning of even the abstracted text A, unlike in the case where the confidential information is masked completely. Accordingly, even if the to-be-processed text Y includes confidential information, it is possible to appropriately disclose information to the reader while reducing leakage of the confidential information.

### 2. Second Embodiment

Next, a second embodiment is described. In the following description, elements that are identical in function to already-described elements are given the same reference signs or reference signs with additional alphabetic characters, and detailed descriptions thereof are omitted.

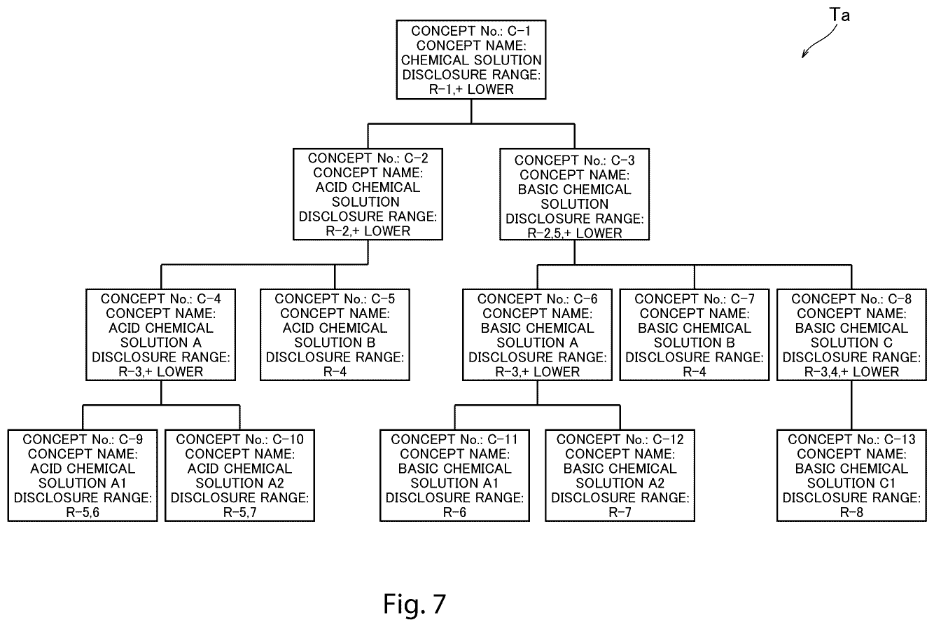

FIG. 7 is a diagram showing a conceptual information tree Ta that is ontology information according to the second embodiment. In the conceptual information tree Ta, each concept has a concept number and a concept name and also has a disclosure range defined. The disclosure range is information indicating the range of reader attributes to which the concept is permitted to be disclosed. In other words, reader information is information indicating whether the reader attribute is included in the disclosure range.

For example, the disclosure range of “acid chemical solution” (C-2) is “R-2, +lower.” This means that the disclosure range includes the reader attribute R-2 and further includes every reader attribute included in the disclosure ranges of lower-level concepts than “acid chemical solution” (specifically, “acid chemical solution A,” “acid chemical solution B,” “acid chemical solution A1,” “basic chemical solution A2,” and “acid chemical solution A2”). In the conceptual information tree Ta, usually, the disclosure ranges are set to become larger as the hierarchical relationship of concepts is at a higher level. For example, the disclosure range of “acid chemical solution” (C-2) is larger than the disclosure ranges of “acid chemical solution A” (C-4) and “acid chemical solution B” (C-5) that are lower-level concepts than “acid chemical solution” (C-2).

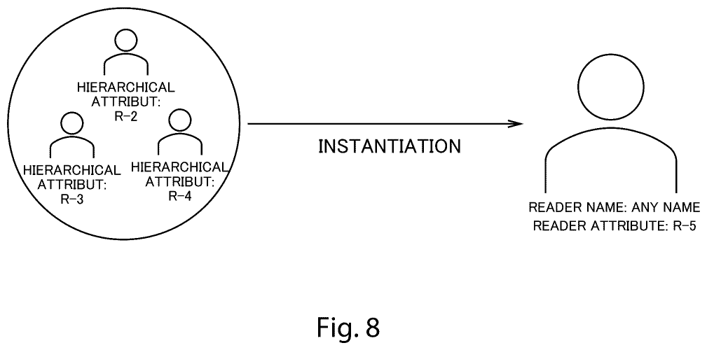

FIG. 8 is a diagram conceptually showing how an instance with the reader attribute R is generated. In the present embodiment, the reader attribute R is defined in advance for each reader. The reader attribute of each reader may be managed in, for example, a database. The information processing apparatus 1 generates an instance with the reader attribute R corresponding to the reader designated by, for example, a user. Alternatively, in the second embodiment, an instance with the reader attribute R corresponding to the hierarchy level of the reader may be generated as described in the first embodiment with reference to FIG. 4.

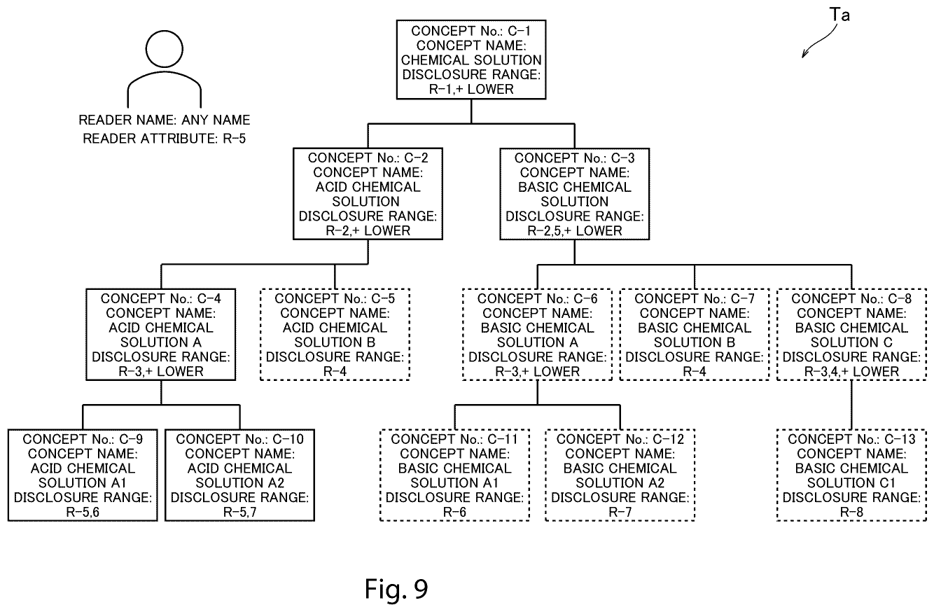

FIG. 9 is a diagram showing concepts that the reader with the reader attribute R-5 is permitted to view in the conceptual information tree Ta shown in FIG. 7. In the case where the reader attribute R of the instance is R-5, the reader is permitted to view concepts that include R-5 in the disclosure ranges (concepts indicated by solid boxes in FIG. 9). The reader is prohibited from viewing concepts that do not include R-5 in the disclosure ranges (concepts indicated by broken boxes in FIG. 9).

In the present embodiment as well, the confidential-information masking part 31 analyzes the to-be-processed text Y to divide the text into words and acquires the reader attribute R of the instance. Then, the confidential-information masking part 31 queries the conceptual information tree Ta to find analyzed words and identifies a word that is included in the to-be-processed text Y but prohibited from being viewed by the reader. Specifically, a word under a concept that is registered in the conceptual information tree Ta and that does not include the reader attribute R of the instance in the disclosure range is identified as a word prohibited from being viewed by the reader. Then, the confidential-information masking part 31 replaces the identified word (object concept) with a word under a concept that is at a higher level than the identified word and that includes the reader attribute R in the disclosure range.

Here, a case is assumed in which the reader attribute R of the instance is “R-5” and the to-be-processed text Y includes “basic chemical solution C1” (C-13). In this case, the disclosure range of “basic chemical solution C1” is only R-8 and does not include R-5. Thus, the confidential-information masking part 31 replaces a word under the concept in the to-be-processed text Y with “basic chemical solution” (C-3) under a higher-level concept that includes R-5 in the disclosure range.

In the present embodiment, the disclosure range is set for each concept (word). Thus, the level of abstraction of the confidential information to the reader can be set in more detail than in the case where the hierarchical attribute D is defined according to the depth of the concept as in the first embodiment.

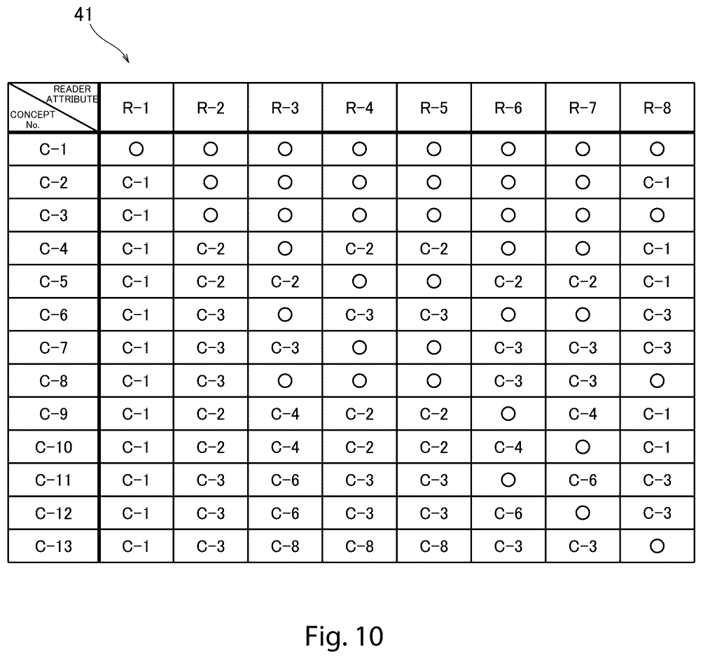

FIG. 10 is a diagram showing a viewable range table 41. In the viewable range table 41, a row header (row label) indicates the concept number, and a column header (column label) indicates the reader attribute R. Each white circle (circle symbol) in the table indicates that the reader attribute R indicated by the column header is permitted to view the concept number indicated by the row header. Each concept number described in the table indicates the replacement destination of the concept number indicated by the corresponding row header that the reader attribute R indicated by the corresponding column header is prohibited from viewing. For example, in the case where the reader attribute R is R-5, the replacement destination for C-13 (basic chemical solution C1) is C-3 (basic chemical solution). Alternatively, the viewable range table 41 defining the replacement designations may be prepared and stored in advance in the memory 13. Then, the confidential-information masking part 31 may perform processing for replacing concepts that are prohibited from being viewed, with reference to the viewable range table 41. This increase processing speed.

### 3. Third Embodiment

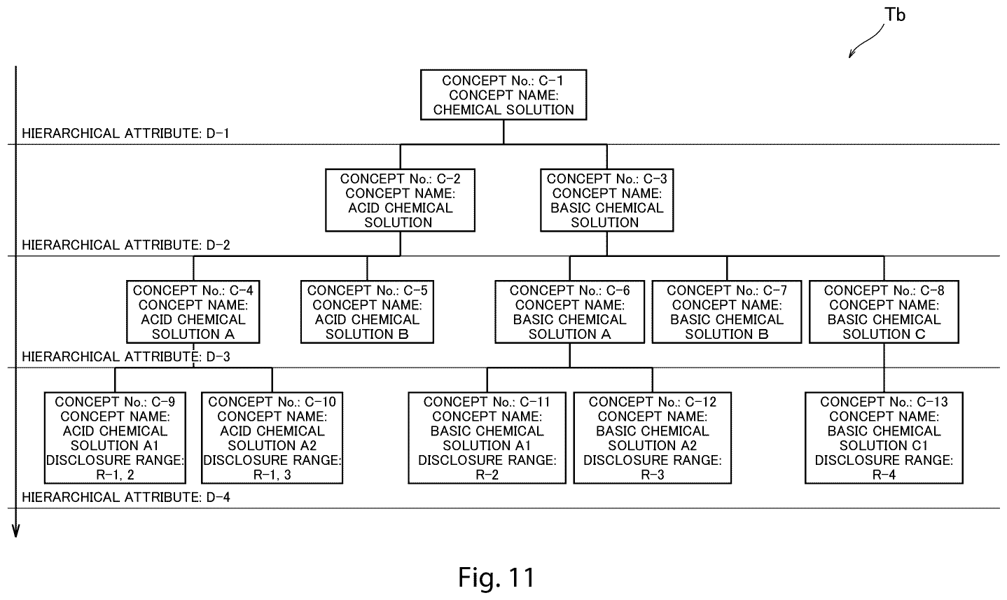

FIG. 11 is a diagram showing a conceptual information tree Tb that is ontology information according to a third embodiment. In the conceptual information tree Tb, the hierarchical attribute D is defined for each concept as in the conceptual information tree T according to the first embodiment. Moreover, the disclosure range described in the second embodiment is defined for some concepts. Here, the disclosure range is defined for concepts that are deep in hierarchy (specifically, lower-level concepts than the hierarchy concept D4). For example, the disclosure range R-4 is defined for “basic chemical solution C1” (C-13) with the hierarchical attribute D-4. In the present embodiment, at least either the reader attribute indicating the hierarchical attribute D or the reader attribute R indicating whether the reader attribute is included in the disclosure range is set as the reader attribute R of an instance.

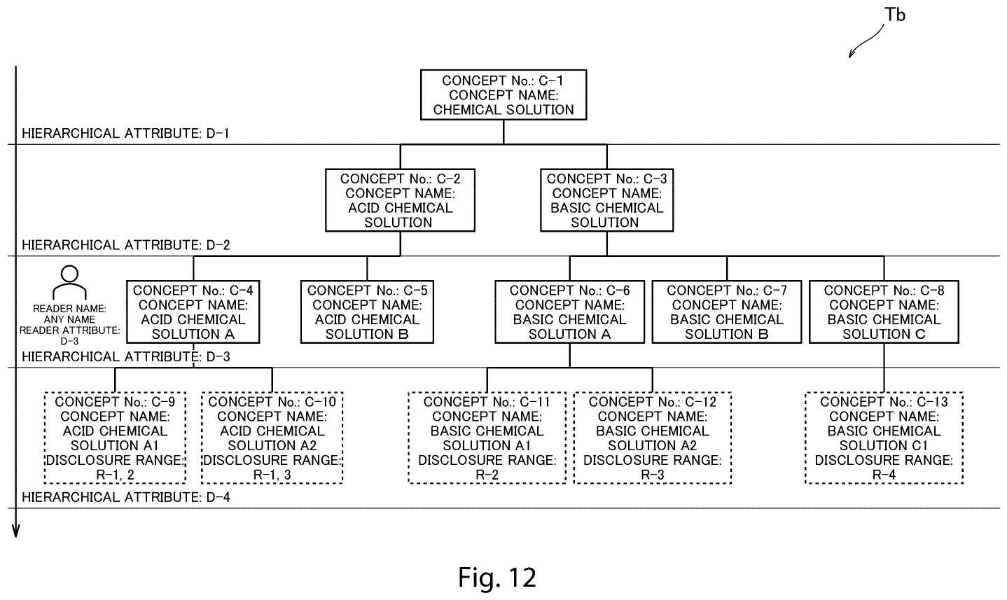

FIG. 12 is a diagram showing concepts that the reader with the reader attribute D-3 is permitted to view. The reader attribute D-3 is the attribute corresponding to the hierarchical attribute D-3. As shown in FIG. 12, the reader with the reader attribute D-3 is permitted to view higher-level concepts than the hierarchical attribute D-3.

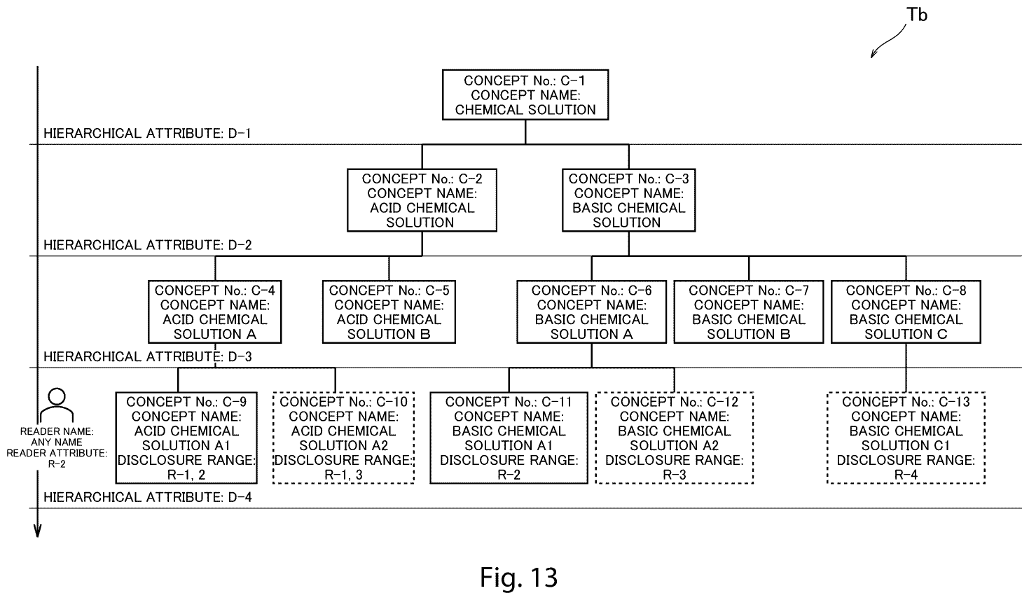

FIG. 13 is a diagram showing concepts that the reader with the reader attribute R-2 corresponding to the disclosure range is permitted to view. As shown in FIG. 13, in the case where the reader attribute R-2 corresponding to the disclosure range has been set, the reader is permitted to view concepts that include R-2 in the disclosure ranges (“acid chemical solution A1” and “basic chemical solution A1”). The concepts that include R-2 in the disclosure ranges appear at lower levels than the hierarchical attribute D-4. Thus, the reader is permitted to view higher-level concepts than the hierarchical attribute D-3.

In this way, defining the hierarchical attribute D and the disclosure range in the conceptual information tree Tb increases the variety of replacement. Moreover, the viewable range table 41 is simplified by defining the disclosure range for only concepts that are at lower conceptual hierarchy levels than a predetermined reference without defining the disclosure range for concepts that are at higher conceptual hierarchy levels than the predetermined reference.

While the present invention has been shown and described in detail, the foregoing description is in all aspects illustrative and not restrictive. It is therefore understood that numerous modifications and variations can be devised without departing from the scope of the present invention.

What is claimed is:

1. An information processing method that is executed by a computer, the information processing method comprising:
a) acquiring to-be-processed text that includes an object concept to be concealed;
b) acquiring a reader attribute that indicates an attribute of a reader of the to-be-processed text; and
c) abstracting, according to the reader attribute, the object concept included in the to-be-processed text by using ontology information that defines a hierarchical relationship of a plurality of concepts.

2. The information processing method according to claim 1, wherein
the ontology information defines a conceptual hierarchy level for each concept,
the reader attribute is information indicating a specific conceptual hierarchy level, and
the operation c) includes abstracting the object concept included in the to-be-processed text when the specific conceptual hierarchy level indicated by the reader attribute is higher than a conceptual hierarchy level of the object concept.

3. The information processing method according to claim 2, wherein
the operation c) includes replacing the object concept included in the to-be-processed text with a concept that is at the specific conceptual hierarchy level indicated by the reader attribute when the conceptual hierarchy level of the object concept is lower than the specific conceptual hierarchy level.

4. The information processing method according to claim 1, wherein
the ontology information defines a disclosure range for each concept,
the reader attribute is information indicating whether the reader attribute is included in the disclosure range, and
the operation c) includes abstracting the object concept included in the to-be-processed text when the reader attribute is not included in the disclosure range of the object concept.

5. The information processing method according to claim 4, wherein
the operation c) includes, when the reader attribute is not included in the disclosure range of the object concept included in the to-be-processed text, replacing the object concept with a concept that is a higher-level concept than the object concept and that includes the reader attribute in the disclosure range.

6. The information processing method according to claim 5, wherein
the disclosure range becomes larger as the hierarchical relationship of concepts is at a higher level in the ontology information.

7. A recording medium having recorded thereon a computer program that is executable by a computer,
the computer program causing the computer to execute the information processing method according to claim 1.
